(19) United States
(12) Patent Application Publication
(10) Pub. No.: US 2008/0090036 A1
(43) Pub. Date: Apr. 17, 2008

(54) Heat-Shrinkable Laminate Film, and Molded Product and Container Using the Film

(75) Inventors: Takashi Hiruma, Nahagama-shi (JP); Takeyoshi Yamada, Nahagama-shi (JP); Yukihiro Tanaka, Nagahama-shi (JP); Jun Takagi, Nagahama-shi (JP)

Correspondence Address: DARBY & DARBY P.C., P.O. BOX 770, Church Street Station, New York, NY, 10008-0770, US

(73) Assignee: MITSUBISHI PLASTICS, INC., Tokyo (JP)

(21) Appl. No.: 11/718,971

(22) PCT Filed: Apr. 27, 2005
(86) PCT No.: PCT/JP05/08063

§ 371 Date: Jun. 12, 2007

(30) Foreign Application Priority Data
Nov. 11, 2004 (JP) 2004-327983

(51) Int. Cl. B65B 53/02; B32B 7/02

(52) U.S. Cl. 428/34.9; 428/213

(57) ABSTRACT

[Problem] To provide a heat-shrinkable laminate film, a molded product and a container, having excellent fracture resistance, rigidity, transparency after addition for regeneration, and in particular excellent shrink finishing quality.

[Means for solving] A heat-shrinkable laminate film is drawn in at least one axial direction including at least three layers having an intermediate layer and front and back layers on respective sides of the intermediate layer. The intermediate layer is constituted by a layer composed mainly of at least one polystyrene-based resin. The front and back layers are constituted by layers composed mainly of at least one polyester-based resin. The front and back layers have a thickness ratio of 75% or less based on the total thickness of the film. The polystyrene-based resin is preferably a block copolymer. Further, preferably the heat-shrinkable laminate film has a birefringence index (Δn) of 1.0×10⁻³ or more and 80.0×10⁻³ or less. A molded product and a container is obtained by using the heat-shrinkable laminate film.

### TECHNICAL FIELD

The present invention relates to a heat-shrinkable laminate film, and to a molded product and a container employing the film. More particularly, the present invention relates to a heat-shrinkable laminate film that has excellent low-temperature shrink characteristics, rigidity (firmness), and finish, and is suitable for particularly a heat-shrinkable label or the like, as well as to a molded product and a container employing the film.

### BACKGROUND ART

Currently, a heat-shrinkable film for a shrinkable label of a plastic container (mainly PET bottle) mainly includes polyester- or polystyrene-based heat-shrinkable films. The polyester-based heat-shrinkable film has improved low-temperature shrink characteristics, low natural shrink ratio, and improved rigidity. However, they do not show uniform shrink, so that there has been problems such as uneven shrink and unacceptable shrink finishing quality. Also, in applications for labels, etc., there occur shrinks in a direction perpendicular to the main shrinking direction, thus giving a poor appearance.

On the other hand, the polystyrene-based heat-shrinkable film includes a polystyrene-based heat-shrinkable film composed mainly of a styrene-butadiene block copolymer (SBS). The polystyrene-based heat-shrinkable film composed mainly of SBS has good shrink finishing quality but has the problem that when imparted with low-temperature shrink characteristics, it has an increased natural shrink ratio. In addition, the problem arises that during printing or bag making, the film itself is deteriorated with the solvent used in the printing, so that the film is broken. Further, in the case of the polystyrene-based heat-shrinkable film composed mainly of a styrene-butadiene block copolymer (SBS), it is possible to improve failure-bearing capability by increasing the amount of butadiene, which is a rubber component. However, in this case, the rigidity of the film is decreased, so that it has been a problem to balance rigidity and rupture resistance.

On the other hand, for example, Japanese Patent Application Laid-Open No. 61-41543 describes a three-kind 5-layered laminate film that includes an intermediate layer composed of polystyrene-based resin, and outermost layers composed of polyester-based resin provided on the intermediate layer. However, the 5-layered film has poor compatibility between a vinyl aromatic hydrocarbon and a conjugated diene derivative in an intermediate layer, and an ethylene-vinyl acetate in an adhesive layer, so that there has been the problem that the transparency of whole film tends to decrease when recycle resins such as cut edges of a film produced by trimming are added (herein after, referred to as “addition for regeneration”). Further, Japanese Patent Application Laid-Open No. 7-137212 and Japanese Patent Application Laid-Open No. 2002-351332 describe laminate films that include a layer of polystyrene resin as an intermediate layer and layers of polyester resin containing 1,4-cyclohexanedimethanol as outer layers. However, the laminate film described in Japanese Patent Application Laid-Open No. 7-137212 has insufficient rupture resistance while the film described in Japanese Patent Application Laid-Open No. 2002-351332 has poor shrink finishing quality and poor transparency after addition for regeneration.

### DISCLOSURE OF THE INVENTION

### Problems to Be Solved by the Invention

To solve the problems of the prior art, it is an object of the present invention to provide a heat-shrinkable laminate film that has excellent rupture resistance, rigidity, transparency after addition for regeneration, and in particular shrink finishing quality.

Another object of the present invention is to provide a molded product, a heat-shrinkable label using the heat-shrinkable laminate film of the present invention having excellent rupture resistance, transparency and shrink finishing quality, and a container provided with the molded product or hear-shrinkable label is attached.

### Means for Solving the Problems

To achieve the above-mentioned objects, the inventors of the present invention have made extensive research on the layer structure and composition of a polyester-based resin and a polystyrene-based resin from the viewpoints of rigidity, rupture resistance, securement of transparency after addition for regeneration. As a result, the present invention has been accomplished.

That is, the object of the present invention can be achieved by a heat-shrinkable laminate film including at least three layers having an intermediate layer and front and back layers laminated on respective sides of the intermediate layer and being drawn at least in one direction, wherein the intermediate layer comprises a layer composed mainly of at least polystyrene-based resin, the front and back layers are formed of a layer composed mainly at least one polyester-based resin, and the front and back layers have a thickness ratio based on the total thickness of 75% or less.

In a preferable embodiment of the heat-shrinkable laminate film of the present invention (herein after, referred to also as “inventive film”), the front and back layers have each a birefringent index (Δn) that can be 1.0×10⁻³ or more and 80.0×10⁻³ or less.

In a preferable embodiment of the inventive film, the film can have a temperature T₃₀, which indicates a heat shrinkage ratio of 30% in a main shrink direction of the film after immersing for 10 seconds in warm water, in a range of 65° C. or more and 80° C. or less.

In a preferable embodiment of the inventive film, the film can have a heat shrinkage ratio of −5% or more and +5% or less in a direction perpendicular to a main shrink direction of the film in a temperature range of T₃₀−10° C. or more and T₃₀+5° C. or less.

In a preferable embodiment of the inventive film, the polystyrene-based resin is preferably a block copolymer. The block copolymer can be a block copolymer of a styrene-based hydrocarbon and a conjugated diene-based hydrocarbon.

In a preferable embodiment of the inventive film, a refractive index (n₁) of a resin that constitutes the intermediate layer and a refractive index (n₂) of a resin that constitutes the front and back layers are in a relation of:
n₂−0.02≧n₁≧n₂+0.02.

In a preferable embodiment of the inventive film, the refractive index (n₁) of the resin that constitutes the intermediate layer can be 1.55 or more and 1.59 or less.

In a preferable embodiment of the inventive film, the refractive index (n₂) of the resin that constitutes the front and back layers can be 1.56 or more and 1.58 or less.

In a preferable embodiment of the inventive film, the block copolymer of the styrene-based hydrocarbon and the conjugated diene-based hydrocarbon can be a styrene-butadiene block copolymer (SBS), a styrene-isoprene-butadiene block copolymer (SIBS), or a mixture of these.

In a preferable embodiment of the inventive film, a mass % ratio of styrene/butadiene of the SBS can be (60 to 95)/(5 to 40).

In a preferable embodiment of the inventive film, a mass % ratio of styrene/isoprene/butadiene of the SIBS can be (60 to 85)/(10 to 40)/(5 to 30).

In a preferable embodiment of the inventive film, the intermediate layer can contain 20 mass % or less of a general-purpose polystyrene resin (GPPS) or 20 mass % or more and 60 mass % or less of the copolymer of a styrene-based hydrocarbon and an aliphatic unsaturated carboxylic acid ester.

In a preferable embodiment of the inventive film, the copolymer of the styrene-based hydrocarbon and the aliphatic unsaturated carboxylic acid ester can be a copolymer of styrene and butyl acrylate.

In a preferable embodiment of the inventive film, a storage elastic modulus (E′) at 0° C. of a resin that constitutes the intermediate layer can be 1.00×10⁹ Pa or more.

In a preferable embodiment of the inventive film, the polyester resin can be composed of a dicarboxylic acid component and a diol component, at least one of which is a mixture of two or more subcomponents (a first subcomponent, a second subcomponent, and optionally other subcomponents(s)), wherein the total amount of the second subcomponent is 10 mol % or more and 40 mol % or less per the sum (200 mol %) of the total amount (100 mol %) of the dicarboxylic acid component and the total amount (100 mol %) of the diol component.

In a preferable embodiment of the inventive film, the dicarboxylic acid component can be terephthalic acid and the first subcomponent of the diol component can be ethylene glycol and the second subcomponent is 1,4-cyclohexanedimethanol.

In a preferable embodiment of the inventive film, an amount of 1,4-cyclohexanedimethanol can be 25 mol % or more and 35 mol % or less per the sum (200 mol %) of the total amount (100 mol %) of the dicarboxylic acid component and the total amount (100 mol %) of the diol component.

In a preferable embodiment of the inventive film, the intermediate layer can further contain a polyester-based resin and a content of the polyester-based resin can be 3 mass % or more and 30 mass % or less per a total amount of a resin that constitutes the intermediate layer.

In a preferable embodiment of the inventive film, the film can have a total haze as measured according to JIS K7105 can be 10% or less.

In a preferable embodiment of the inventive film, the film can have a heat shrinkage ratio of 10% or more in a main shrink direction after immersion for 10 seconds in warm water at 70° C.

In a preferable embodiment of the inventive film, the film can have an adhesive layer having a glass transition temperature (Tg) of 20° C. or less between the intermediate layer and the front and back layers.

Another object of the present invention can be achieved by a molded product and a heat shrinkable label using the heat-shrinkable laminate film as a base material as well as a container provided with the molded article or heat-shrinkable label is attached.

### EFFECTS OF THE INVENTION

In the inventive film including at least three layers having an intermediate layer composed mainly of a polystyrene-based resin and a front layer and a back layer composed mainly of a polystyrene-based resin, the front and back layers are constituted by the predetermined polyester-based resin and are set to have a thickness ratio of the front and back layers in the film in a predetermined range. Preferably, the birefringence index (Δn) of the front and back layers is adjusted in a predetermined range as well as the heat shrinkage ratio of the film is adjusted in a predetermined range and further a difference between the refractive index (n₁) of the resin that constitutes the intermediate layer and the refractive index (n₂) of the resin that constitutes the front and back layers is adjusted in a predetermined range. As a result, according to the present invention, a heat-shrinkable laminate film having excellent low-temperature shrink characteristics and rigidity, in particular, for label use, having excellent rupture resistance and shrink finishing quality as well as excellent transparency after addition for regeneration can be provided.

Further, by using the above-mentioned heat-shrinkable laminate film as a base material, according to the present invention a molded product and a heat-shrinkable label having acceptable rupture resistance and shrink finishing quality in combination, and a container provided with the molded product or the label can be provided.

### BEST MODE FOR CARRYING OUT THE INVENTION

Hereinafter, the film, molded product, heat-shrinkable label and container of the present invention are described in detail.

Note that regarding interpretation of upper and lower limit values of numerical ranges in the present invention, those numerical values which are slightly outside the numerical range defined in the present invention should be considered to be included in a scope of equivalents of the present invention as far as the same or similar effects as those in the numerical range.

[Heat-Shrinkable Laminate Film]

<Lamination Ratio and Birefringent Index>

The inventive film is a heat-shrinkable film obtained by drawing, in at least one direction, a laminate film having at least three layers that include an intermediate layer constituted by a layer mainly composed of at least one polystyrene-based resin, and a front layer and a back layer laminated on respective sides of the intermediate layer and constituted by a layer mainly composed of at least one polyester-based resin.

In the inventive film, the thickness ratio of the front and back layers to the total thickness of the film is set to 75% or less, preferably 60% or less, and more preferably 50% or less as an upper limit, and 10% or more, preferably 15% or more, and more preferably 20% or more as an under limit. For example, the thickness ratio of the intermediate layer to the front and back layers is in a range of preferably 1/2/1 to 1/12/1, and more preferably 1/4/1 to 1/8/1. Further, in the inventive film, it is desirable that the lower limit of the birefringent index (Δn) of the front and back layers is adjusted to a range of 1.0×10⁻³ or more, preferably 15.0×10⁻³ or more, and more preferably 20.0×10⁻³ or more, and the upper limit of the birefringent index (Δn) of the front and back layers is adjusted to a range of 80.0×10⁻³ or less, preferably 75.0×10⁻³ or less, and more preferably 73.0×10⁻³ or less.

Although the polyester-based heat-shrinkable film has acceptable low-temperature shrink characteristics and rigidity as well as low natural shrink ratio, uniform heat shrinkage is not obtained, so that there occurs uneven shrink and also shrink in a direction perpendicular to the main shrink direction of the film. As a result, the polyester-based heat-shrinkable film has the problem that defective appearance occurs after hear shrinkage was performed. So that the polyester-based heat-shrinkable film can exhibit a predetermined heat shrinkage ratio in the main shrink direction of the film, it is necessary to control the crystallinity and adjust drawing conditions. However, with this adjustment, the polyester-based heat-shrinkable film tends to have an increased degree of orientation relative to the main shrink direction of the film, indicating degree of drawing, i.e., an increased birefringent index (Δn). As a result, the polyester-based heat-shrinkable film, which has a highly shrinkable film that has a large orientation in the main shrink direction of the film, has a heat shrink curve too steep and causes uneven shrink and tends to generate shrink or expansion in a direction perpendicular to the main shrink direction of the film as a reaction.

Note that the term “main shrink direction of the film” as used herein refers to one of a vertical direction and a horizontal direction, which direction (TD) has a larger draw ratio than the other. For example, when the film is attached to a bottle, the main shrink direction of the film means a direction that corresponds to a circumferential direction of the bottle.

The inventors of the present invention has made extensive studies in order to solve the above-mentioned problem and as a result, they have found that to enable to impart a film with shrink characteristics under mild draw conditions, laminating a polyester-based resin layer and a polystyrene-based resin layer and adjusting a lamination ratio, that is, an amount of the polyester-based resin to the amount of the whole film, preferably decreasing the degree of orientation of the polyester-based resin, that is, decreasing birefringent index (Δn), can impart the film with rupture resistance and rigidity and at the same time excellent shrink finishing quality while keeping low-temperature shrink characteristics and low natural shrinkage which the polyester-based resin has.

In the inventive film, the mass of the polyester-based resin that constitutes the front and back layers should be within a predetermined range. To do so, it is important to adjust a ratio (lamination ratio) of a thickness of the front and back layers (a sum of thicknesses of the front layer and the back layer) to a thickness of the whole film to 75% or less. If such a thickness ratio is 75% or less, acceptable shrink characteristics can be obtained without a need for adjusting draw conditions in accordance with the characteristics of the polyester-based resin. On the other hand, the lower limit of the thickness ratio is preferably 10% or more. If the thickness ratio is 10% or more, one can make the most of the characteristics of the polyester-based resin.

Further, in the inventive film, it is preferable that the birefringent index (Δn) of the front and back layers that are composed mainly of the polyester-based resin is in a range of 1.0×10⁻³ or more and 80.0×10⁻³ or less. When the birefringent index (Δn) of front and back layers is 1.0×10⁻³ or more, the shrink characteristics of the polyester-based resin layer can be exhibited, so that acceptable heat-shrinkage ratio can be obtained. On the other hand, when the birefringent index (Δn) of the front and back layers is 80.0×10⁻³ or less, abrupt change in shrinkage ratio and change in shrink in the direction perpendicular to the main shrink direction are suppressed and acceptable shrink finishing quality can be obtained. The birefringence index (Δn) of the front and back layers can be measured by an Abbe refractometer according to JIS K7142.

To adjust the birefringence index (Δn) of the front and back layers so as to be in the above-mentioned range, it is important to adjust draw conditions in the main shrink direction of the film. That is, the draw temperature is adjusted so as to be in a range of 85° C. or more, preferably 90° C. or more, and as an upper limit in a range of 120° C. or less, preferably 110° C. or less, more preferably 100° C. or less. The temperature condition is relatively high as a draw temperature of the polyester-based resin. However, by adjusting the mass of the polyester-based resin that constitutes the front and back layers to the above-mentioned thickness ratio, the obtained film can be drawn even at a relatively high temperature condition, so that an extreme in crease in birefringent index (Δn) can be suppressed.

Further, the draw ratio is adjusted in a range of 3.0 times or more, preferably 3.5 times or more, and more preferably 4.0 times or more, while as an upper limit 6.0 times or less, and preferably 5.0 times or less. By drawing a film under these draw conditions, along with shrink characteristics of the polystyrene-based resin that constitutes the intermediate layer, the orientation of the polyester-based resin that constitutes the front-back layer can be suppressed in the main shrink direction of the film and as a result occurrence of heat shrinkage in a direction perpendicular to the main shrink direction of the film can be suppressed as compared with the case of a general polyester-based heat shrinkable film. Further, since the orientation in the main shrink direction of the film is suppressed under the above-mentioned draw conditions, an increase in rupture resistance in a direction perpendicular to the main shrink direction of mainly films for labels can also be expected.

<Shrink Characteristics>

The inventive film has a heat-shrinkage ratio of 30% or more, and more preferably 40% or more in the main shrink direction of the film after the film is immersed in warm water of 80° C. for 10 seconds. Further, the inventive film has preferably a heat-shrinkage ratio of 10% or more in the main shrink direction of the film after the film is immersed in warm water of 70° C. for 10 seconds. When the inventive film is used as a heat-shrinkable film for a label to be attached to PET product, the film has preferably a heat-shrinkage ratio of 10% or less, more preferably 5% or less, and further more preferably 3% or less in a direction perpendicular to the main shrink direction of the film after the film is immersed in warm water at 80° C. for 10 seconds. When the heat-shrink ratios in a main shrink direction of the film and in a direction perpendicular to the main shrink direction of the film are in the above-mentioned ranges, it would not occur that when the film is used for a label application, the shrink in the vertical direction becomes remarkable after the film shrink, and neither a size deviation nor a defective appearance occurs. Further, by promptly performing cooling of the film after the drawing in a time in which the molecular orientation of the film is not relaxed, shrink characteristics can be imparted and retained.

Preferably, the inventive film has a thickness ratio of the front and back layers and a birefringent index (Δn) of the front and back layers within the above-mentioned ranges as well as a temperature T₃₀, which indicates a heat-shrinkage ratio of 30% in a main shrink direction of the film after immersing for 10 seconds in warm water, in a range of 65° C. or more and 80° C. or less. Further, the inventive film preferably has a heat-shrinkage ratio of −5% or more and +5% or less in a direction perpendicular to a main shrink direction of the film in a temperature range of T₃₀−10° C. or more and T₃₀+5° C. or less.

It is preferable that as described above, the temperature T₃₀, at which the heat-shrinkage ratio of the film is 30%, is in the range of 65° C. or more and 80° C. or less, more preferably in the range of 70° C. or more and 80° C. or less, and particularly preferably in the range of 70° C. or more and 75° C. or less. When T₃₀ is 65° C. or more, occurrence of wrinkles due to abrupt heat shrink upon labeling a bottle or the like can be suppressed. When T₃₀ is 80° C. or less, sufficient heat shrinkage can be obtained at the time of labeling.

Further, it is desirable that the heat-shrinkage ratio in a direction perpendicular to a main shrink direction of the film in a temperature range of T₃₀−10° C. or more and T₃₀+5° C. or less is in the range of −5% or more and +5% or less, preferably −5% or more and +3% or less, more preferably in the range of −3% or more and +2% or less. When the heat shrinkage ratio is in the range of −5% or more and +5% or less, the heat shrinkage in the main shrink direction of the film and at the same time a change in shrink in a direction perpendicular to the main shrink direction are small, so that occurrence of mainly horizontal wrinkles due to expansion change (negative side) and occurrence of size deviation due to a large longitudinal dragging as a result of a shrink change (positive side) can be suppressed, so that acceptable shrink finishing quality can be obtained.

Next, the front and back layers and intermediate layer that constitute the inventive film are described.

Note that “as a main component” as used relative to the front and back layers and intermediate layer refers to the fact that the component occupies 50 mass % or more, preferably 75 mass % or more, and more preferably 85 mass % or more based on the total mass of the whole resin that constitutes the front and back layers and intermediate layer.

<Front and Back Layers>

Each of the front and back layers of the inventive film is constituted by at least one polyester-based resin as a main component. The polyester-based resin imparts the whole film with rigidity and rupture resistance and also has a function of suppressing natural shrink while imparting low temperature shrink to the whole film. In the present invention, the type of polyester-based resin is not particularly limited as far as the above-mentioned functions can be imparted. The polyester-based resin is not limited to a simple substance but a mixture composition obtained by blending two or more polyester-based resins. Preferable polyester-based resins include those polyester-based resins derived from a dicarboxylic acid component and a diol component.

Examples of the dicarboxylic acid component include aromatic dicarboxylic acids such as terephthalic acid, isophthalic acid, 2-methylterephthalic acid, 4,4-stilbenedicarboxylic acid, 4,4-biphenyldicarboxylic acid, orthophthalic acid, 2,6-naphthalenedicarboxylic acid, 2,7-naphthalenedicarboxylic acid, bisbenzoic acid, bis(p-carboxyphenyl)methane, anthracenedicarboxylic acid, 4,4-diphenylehterdicarboxylic acid, 4,4-diphenooxyethanedicarboxylic acid, 5-Na sulfoisophthalic acid, and ethylene-bis-p-benzoic acid; aliphatic dicarboxylic acids such as succinic acid, glutaric acid, adipic acid, suberic acid, sebacic acid, azelaic acid, dodecanedioic acid, 1,3-cyclohexanedicarboxylic acid, and 1,4-cyclohexanedicarboxylic acid.

Examples of the diol component include diethylene glycol, triethylene glycol, polyethylene glycol, ethylene glycol, 1,2-propylene glycol, 1,3-propanediol, 2,2-dimethyl-1,3-propanediol, trans-tetramethyl-1,3-cyclobutanediol, 2,2,4,4-tetramethyl-1,3-cyclobutanediol, 1,4-butanediol, neopentyl glycol, 1,5-pentanediol, 1,6-hexanediol, 1,4-cyclohexanedimethanol, 1,3-cyclohexanedimethanol, decamethylene glycol, cyclohexanediol, p-xylenediol, bisphenol A, tetrabromobisphenol A, and tetrabromobisphenol A-bis(2-hydroxyethyl ether).

The polyester-based resin used in the present invention preferably is a mixture of a dicarboxylic acid component and a diol component, at least one of these includes two or more components. In the present specification, of the two or more types of the components, a main component, that is, one having the largest amount (mol %) is named a first subcomponent and components having smaller amounts than the first subcomponent is named a second subcomponent and subsequent subcomponents (that is, second subcomponent and other subcomponent(s), specifically, a second subcomponent, a third subcomponent, . . . , an n-th subcomponent). By using such a mixture of dicarboxylic component and diol component, the crystallinity of the obtained polyester-based resin can be suppressed to a lower level and even when blended in a resin that constitutes the front and back layers, the progress of crystallization can be suppressed. Accordingly, use of the above-mentioned mixture is preferable.

A preferable diol component mixture is one that includes ethylene glycol as the first subcomponent and at least one selected from the group consisting of 1,4-butanediol, neopentyl glycol, diethylene glycol, polytetramethylene glycol, and 1,4-cyclohexanedimethanol as the second subcomponent and subsequent subcomponent(s), with 1,4-cyclohexanedimethanol being preferable.

A preferable dicarboxylic acid component mixture is one that includes terephthalic acid as the first subcomponent, and at least one selected from the group consisting of isophthalic acid, 1,4-cyclohexanedicarboxylic acid, succinic acid, and adipic acid as the second subcomponent and subsequent subcomponent(s), with isophthalic acid being preferable.

The total amount of the second and subsequent subcomponents is 10 mol % or more and preferably 20 mol % or more and as a upper limit 40 mol % or less and more preferably 35 mol % or less based on the sum (200 mol %) of the total amount (100 mol %) of the dicarboxylic acid component and the total amount (100 mol %) of the diol component. When the total amount of the second and subsequent subcomponents is equal to or more than the above-mentioned lower limit, polyester-based resin compositions having suitable crystallinity can be obtained while when the total amount of the second and subsequent subcomponents is equal to or less than the above-mentioned upper limit, one can make most of the advantage of the first subcomponent. When ethylene glycol and 1,4-cyclohexanedimethanol are used, the content of 1,4-cyclohexanedimethanol is in the range of 10 mol % or more and 40 mol % or less, preferably 25 mol % or more and 35 mol % or less based on the sum, 200 mol %, of the total amount (100 mol %) of ethylene glycol and 1,4-cyclohexanedimethanol and the total amount (100 mol %) of the dicarboxylic acid component. By using ethylene glycol and 1,4-cyclohexanedimethanol within such ranges of contents, the obtained polyester has substantially no crystallinity and the rupture resistance thereof is improved.

The polyester-based resin used as the main component of the front and back layers has a weight (mass) average molecular weight of 30,000 or more, preferably 35,000 or more as a lower limit value and 80,000 or less, preferably 75,000 or less, more preferably 70,000 or less as an upper limit value. When the weight (mass) average molecular weight is 30,000 or more, the resin has a moderate resin cohesive force so that insufficiency of film strength and ductility and embrittlement can be avoided. On the other hand, when the weight (mass) average molecular weight is 80,000 or less, the melt viscosity of the resin can be decreased, which is preferable from the viewpoints of production and improvement of productivity.

The polyester-based resin used as the main component in the front and back layers has an intrinsic viscosity (IV) of 0.5 dl/g or more, preferably 0.6 dl/g or more, more preferably 0.7 dl/g or more as a lower limit value and 1.5 dl/g or less, preferably 1.2 dl/g or less, and more preferably 1.0 dl/g or less as an upper limit value. When the intrinsic viscosity (IV) is 0.5 dl/g or more, a decrease in film strength property can be suppressed while when the intrinsic viscosity (IV) is 1.5 dl/g or less, breakage or the like due to an increase in tension upon drawing can be prevented.

The refractive index of the polyester-based resin used as the main component in the front and back layers is preferably in the range of 1.56 or more and 1.58 or less, more preferably in the range of 1.565 or more and 1.575 or less. When the refractive index of the polyester-based resin is in the above-mentioned range, the refractive index of the intermediate layer after addition for regeneration can be adjusted so as to be in a predetermined range (1.55 or more and 1.59 or less).

As the polyester-based resin, for example “PETG6763” (manufactured by Eastman Chemical Co.) and “SKYREEN PETG” (manufactured by SK Chemicals Co.) are commercially available.

<Intermediate Layer>

The intermediate layer of the inventive film is constituted by a layer composed mainly of at least one polystyrene-based resin. The polyester-based resin, as described above, can impart the film with rigidity and rupture resistance and can suppress natural shrink while imparting low temperature shrinkage. However, the polyester-based heat-shrinkable film cannot provide uniform heat shrinkage so that there arise problems such as failure of shrink finishing quality such as uneven shrink and for label applications, occurrence of shrink in a direction perpendicular to the main shrink direction, thus causing poor appearance. Accordingly, by constituting the front and back layers by the polyester-based resin as the main component and the intermediate layer by the polystyrene-based resin as the main component, the above-mentioned problems can be solvable. That is, by constituting the intermediate layer by the polystyrene-based resin, the shrink finishing quality that could not be solved by use of the polyester-based resin alone can be solved and heat shrinkage in a direction perpendicular to the main shrink direction can be suppressed for label applications. This enables to provide a heat-shrinkable film that has rigidity, rupture resistance, and low natural shrinkage in combination and improve in shrink finishing quality thereof.

The polystyrene-based resin used as the main component of the intermediate layer may include various polystyrene resins. However, when the polystyrene-based resin contains more than 50 mass % of a rubbery elastic body-dispersed polystyrene resin, the effects of the present invention cannot be obtained. From the viewpoint of adjusting the birefringence index (Δn) of the front and back layers constituted by the polyester-based resin as the main component to be in the predetermined range to provide a moderate shrink change and adjusting the shrink ratio in a direction perpendicular to main shrink direction of the film to be in the predetermined range, it is preferable that a block copolymer is used and a block copolymer of a styrene-based hydrocarbon and a conjugated diene-based hydrocarbon can be advantageously used.

Note that “block copolymer” as used herein includes any one of a pure block in which the resin is pure in each block, a random block in which comonomer components are mixed and form a block, and a taper block in which comonomer concentration is tapered.

Examples of the styrene-based hydrocarbon include alkylstyrenes such as styrene, (p-, m- or o-)methylstyrene, (2,4-, 2,5-, 3,4- or 3,5-)dimethylstyrene, and p-t-butylstyrene; alkoxystyrenes such as (p-, m- or o-)methoxystyrene, and (o-, m- or p-)ethoxystyrene; carboxyalkylstyrenes such as (o-, m- or p-)carboxymethylstyrene; alkyl ether styrene such as p-vinylbenzyl propyl ether; alkylsilylstyrenes such as p-trimethylsilylstyrene; and vinylbenzyldimethoxyphosphide. The styrene-based hydrocarbon block may contain homopolymers thereof, copolymers thereof and/or copolymerizable monomers other than the styrene-based hydrocarbon in the block.

Examples of the conjugated diene-based hydrocarbon include butadiene, isoprene, and 1,3-pentadiene. The conjugated diene-based hydrocarbon block may contain homopolymers thereof, copolymers thereof and/or copolymerizable monomers other than the conjugated diene-based hydrocarbon in the block.

One of the block copolymer of the styrene-based hydrocarbon and conjugated diene-based hydrocarbon preferably used in the present invention is styrene-butadiene based block copolymer (SBS) in which the styrene-based hydrocarbon is styrene and the conjugated diene-based hydrocarbon is butadiene. SBS has a mass % ratio of styrene/butadiene of preferably about (60 to 95)/(5 to 40), more preferably (60 to 90)/(10 to 40). Further, it is desirable that melt flow rate (MFR) measured values (measurement conditions: temperature of 200° C., load of 49N) are 2 g/10 minutes or more, preferably 3 g/10 minutes or more, and 15 g/10 minutes or less, preferably 10 g/10 minutes or less.

In the present invention, the polystyrene-based resin that constitutes the main component of the intermediate layer may be either a simple substance or a mixed resin of two or more of them. It is desirable that the simple substance or mixed resin that constitutes the intermediate layer has a refractive index of 1.54 or more, preferably 1.55 or more, and more preferably 1.56 or more, still more preferably 1.57 or more, and 1.59 or less, preferably 1.585 or less, more preferably 1.58 or less as an upper limit. The resin that constitutes the intermediate layer has a refractive index in the range of 1.55 or more and 1.59 or less, acceptable transparency can be secured. For example, when back printing is performed, the printed pattern is clearly visible, so that it is preferable from the viewpoint of obtaining excellent appearance.

The present invention relates to a laminate film that is obtained by laminating an intermediate layer composed mainly of a polystyrene-based resin and front and back layers composed mainly of a polyester-based resin. Generally, when a heat-shrinkable film is produced, by slitting a clip portion, for example, at the time of tenter drawing or by slitting the film according to the width of the product, a portion that is not a product (trimming loss, etc.) occurs. Such a non-product portion is usually added for a regenerated product (addition for regeneration) at the time of extrusion. In the case of laminate films as in the present invention, the slit non-product portion (regenerated product) contains the materials of the both layers in admixture. The mixture of the materials of the both layers is added for regeneration in the intermediate layer or front and back layers, the transparency of the film may be decreased. Therefore, in applications in which transparency of the film is needed, the refractive indices of the resins that constitute the both layers must be as close as possible to each other to maintain the transparency thereof.

For example, assuming the refractive index of the resin that constitutes the front and back layers is indicated by n₂, and the refractive index of the resin that constitutes the intermediate layer is indicated by n₁, it is preferable that n₁ and n₂ satisfy the relational expression: n₂−0.02≦n₁≦n₂+0.02.

While the refractive index (n₂) of the resin that constitutes the front and back layers may vary more or less depending on the copolymerizable monomer of the polyester-based resin that constitutes the layer, many of the polyester-based resins have a refractive index in the range of 1.55 or more and 1.585 or less. Therefore, setting the refractive index (n₂) of the resin that constitutes the front and back layers to the above-mentioned range enables the transparency of the film to be maintained even when a mixture of the resin for front and back layers and the resin for the intermediate layer is added for regeneration to the intermediate layer and/or front and back layers.

On the other hand, when the intermediate layer is constituted by the polystyrene-based resin, it is preferable to use a block copolymer of the styrene-based hydrocarbon and the conjugated diene-based hydrocarbon in order to adjust the refractive index (n₁) of the resin that constitutes the intermediate layer to the above-mentioned range. The block copolymer of the styrene-based hydrocarbon and the conjugated diene-based hydrocarbon can have a refractive index of approximately a predetermined value by adjustment of the compositional ratio of the styrene-based hydrocarbon and conjugated diene-based hydrocarbon. The predetermined refractive index can be achieved with a simple substance of the block copolymers of the styrene-based hydrocarbon and the conjugated diene-based hydrocarbon or two or more of mixed resins. Therefore, it is desirable that the block copolymer of the styrene-based hydrocarbon and the conjugated diene-based hydrocarbon used as main component of the intermediate layer has a refractive index of 1.54 or more, preferably 1.55 or more, and more preferably 1.555 or more and 1.60 or less, preferably 1.59 or less, and more preferably 1.585 or less. Note that the measuring method for refractive indices is described in detail in examples.

When a mixed resin is used as a resin that constitutes the intermediate layer, the refractive indices thereof can be determined by addition calculation of refractive indices of respective resins as multiplied by mass fraction. For example, in the case of styrene-butadiene block copolymer of styrene/butadiene=95/5, the refractive index may vary depending on the block structure and no general statement can be made. However, since the refractive index in this case is approximately 1.587, when this copolymer is mixed, an average refractive index of the intermediate layer can be adjusted to the above-mentioned range by blending with a styrene-butadiene block copolymer having a low refractive index.

Examples of the styrene-butadiene block copolymer that can be commercially available include ASAFLEX series, manufactured by Asahi Kasei Chemicals Co., Ltd., CLEARENE series, manufactured by Denki Kagaku Kogyo Co., Ltd., K RESIN, manufactured by Chevron Phillips, STYROLUX, manufactured by BASF, and FINACLEA, manufactured by Atofina Co.

Further, in the present invention, also styrene-isoprene-butadiene block copolymer (SIBS) can be advantageously used as the polystyrene-based resin that constitutes the main component of the intermediate layer. In SIBS, the mass % ratio of styrene/isoprene/butadiene is preferably (60 to 85)/(10 to 40)/(5 to 30), and more preferably (60 to 80)/(10 to 25)/(5 to 20). The melt flow rate (MFR) measured values (measurement conditions: temperature of 200° C., load of 49N) are 2 g/10 minutes or more, preferably 3 g/10 minutes or more, and 15 g/10 minutes or less, preferably 10 g/10 minutes or less. When the butadiene content and the isoprene content are in the above-mentioned range, the crosslinking reaction of butadiene heated in the extruder can be suppressed, the occurrence of gel-like products can be suppressed, and unit price of the material can be suppressed to a low level, which is preferable.

The styrene-isoprene-butadiene block copolymer includes, for example, commercially available one such as ASAFLEX I series, manufactured by Asahi Kasei Chemicals Co., Ltd.

The polystyrene-based resin used as the main component in the intermediate layer has a weight (mass) average molecular weight (Mw) of 100,000 or more, preferably 150,000 or more, and 500,000 or less, preferably 400,000 or less, and more preferably 300,000 or less as an upper limit. When the polystyrene-based resin has a weight (mass) average molecular weight of 100,000 or more, the film causes no deterioration and thus is preferable. Further, when the polystyrene-based resin has a weight (mass) average molecular weight of 500,000 or less, there is no need for adjusting flow characteristics of the resin and there is no defect such as a decrease in extrudability and thus such a polyester resin is preferable.

In the present invention, the resin that constitutes the intermediate layer has a storage elastic modulus (E′) at 0° C. of 1.00×10⁹ Pa or more, preferably 1.50×10⁹ Pa or more, and 3.00×10⁹ Pa or less, preferably 2.50×10⁹ Pa or less. The storage elastic modulus at 0° C. indicates rigidity of the film, that is, a nerve of film. By having a storage elastic modulus equal to or more than the above-mentioned lower limit value, a film having rigidity in addition to transparency can be obtained. Such a storage elastic modulus may be achieved by blending the above-mentioned polystyrene-based resin, the block copolymer of styrene-based hydrocarbon and conjugated diene-based hydrocarbon, two or more mixed resins, or other resins as far as the transparency is not deteriorated.

It has now been found that when the mixed resin or a blend with other resin is used, selection of a resin that bears rupture resistance and a resin that bears rigidity leads to good results. That is, combining a polystyrene-based resin and so on having high rupture resistance with a polystyrene-based resin and so on having high rigidity or another resin enables a desired refractive index (n₁) and a desired storage elastic modulus (E′) to be satisfied.

The polystyrene-based resin and so on that bears rupture resistance is preferably an SBS having viscoelastic characteristics such that a storage elastic modulus at 0° C. is 1.00×10⁸ Pa or more and 1.00×10⁹ Pa or less and at least one peak temperature of loss elastic modulus is −20° C. or less. A temperature of low temperature side in a peak temperature of the loss elastic modulus shows rupture resistance mainly. Although the characteristics may vary depending on the drawing conditions, if the peak temperature of loss elastic modulus in a state before the drawing is −20° C. or less, sufficient film failure-bearing capability can be imparted to the laminate film.

The polystyrene-based resin and so on that bears rigidity is a copolymer of styrene-based hydrocarbon having a storage elastic modulus (E′) at 0° C. of 2.00×10⁹ Pa or more, for example, a block copolymer of styrene-based hydrocarbon and conjugated diene-based hydrocarbon having a controlled block structure and a polystyrene, a copolymer of styrene-based hydrocarbon and an aliphatic unsaturated carboxylic acid ester.

The block copolymer of styrene-based hydrocarbon and conjugated diene-based hydrocarbon having a controlled block structure includes an SBS having a storage elastic modulus (E′) at 0° C. of 2.00×10⁹ Pa or more, preferably 2.50×10⁹ Pa or more, and 4.00×10⁹ Pa or less, preferably 3.00×10⁹ Pa or less. The styrene-butadiene compositional ratio of SBS that satisfy this condition is preferably adjusted to approximately to styrene/butadiene=95/5 to 80/20. The structure of the block copolymer and the structure of each block portion are preferably a random block and a tapered block.

To control the shrink characteristics, it is preferable that the peak temperature of loss elastic modulus is 40° C. or more. Further, more preferably, it is desirable that no clear peak temperature of loss elastic modulus exists at 40° C. or less. When apparently no peak temperature of loss elastic modulus is present until 40° C., the film shows substantially the same storage elastic modulus characteristics as that of polystyrene, so that the film can be imparted with rigidity. Further, the peak temperature of loss elastic modulus is present at 40° C. or more, preferably 40° C. or more and 90° C. or less. This peak temperature is a factor that gives an influence mainly on shrink ratio. When this temperature is 40° C. or less, natural shrink is decreased while when this temperature is 90° C. or more, low temperature shrinkage is decreased.

A polymerization method that enables the above-mentioned viscoelastic characteristics to be satisfied is exemplified below. After a portion of styrene or butadiene is charged and polymerization is completed, a mixture of a styrene monomer and a butadiene monomer is charged and the polymerization reaction is continued. This allows butadiene having a higher polymerization activity to be polymerized preferentially and finally a block of styrene monomer alone is formed. For example, when styrene alone is first polymerized and polymerization is completed, and then a mixture of a styrene monomer and a butadiene monomer is charged and the polymerization is continued, there can be obtained a styrene-butadiene block copolymer that includes a styrene block, a butadiene block, and a styrene-butadiene copolymer portion between the styrene block and the butadiene block with its styrene/butadiene monomer ratio being gradually changed. Introduction of such a portion enables to provide a polymer having the above-mentioned viscoelastic characteristics. In this case, two peaks ascribable to the butadiene block and the styrene block as described above cannot be clearly confirmed and apparently only one peak seems to be present. That is, in a block structure such as SBS of a random block structure in which pure block and/or butadiene block are clearly present, Tg ascribable to the butadiene block exists mainly at 0° C. or less, so that it is difficult to increase the storage elastic modulus at 0° C. to a predetermined value or more. The weight (mass) average molecular weight is adjusted such that the melt flow rate (MFR) measured values (measurement conditions: temperature of 200° C., load of 49N) is 2 g/10 minutes or more, and 15 g/10 minutes or less. While the blend amount of the styrene-butadiene block copolymer that imparts the rigidity is adjusted as appropriate depending on the characteristics of the heat-shrinkable laminate film, it is preferable that the blend amount of the styrene-butadiene block copolymer is adjusted in the range of approximately 20 mass % or more and 70 mass % or less. When the blend amount is 70 mass % or less, the rigidity of the film can be greatly increased without greatly decreasing rupture resistance. On the other hand, when the blend amount is 20 mass % or more, the effect of imparting the film with rigidity can be obtained.

The polystyrene-based resin blended as the resin that bears rigidity is preferably a general-purpose polystyrene resin (GPPS) having a weight (mass) average molecular weight (Mw) of 100,000 or more and 500,000 or less. The polystyrene has a very high glass transition temperature (peak temperature of loss elastic modulus) as high as about 100° C., so that it is desirable that the blend amount is 20 mass % or less, preferably 15 mass % or less, and more preferably 10 mass % or less. When the blend amount is 20 mass % or less, the heat shrinkage ratio of the laminate film at low temperatures, that is, a heat shrinkage ratio after immersed in warm water at 70° C. for 10 seconds can be made 10% or more.

The styrene-based hydrocarbon to be blended as the resin bearing rigidity in the copolymer of styrene-based hydrocarbon and aliphatic unsaturated carboxylic acid ester includes preferably styrene, o-methylstyrene, p-methylstyrene, α-methylstyrene, etc. are preferable and preferred examples of the aliphatic unsaturated carboxylic acid ester include methyl (meth)acrylate, butyl (meth)acrylate, 2-ethylhexyl (meth)acrylate, lauryl (meth)acrylate, and stearyl (meth)acrylate. Here, (meth)acrylate refers to acrylate and/or methacrylate. Preferably, a copolymer of styrene and butyl (meth)acrylate is used. More preferably, the copolymer that can be used contains styrene in the range of 70 mass % or more and 90 mass % or less, has a glass transition temperature (peak temperature of loss elastic modulus) of 50° C. or more and 90° C. or less, melt flow rate (MFR) measured values (measurement conditions: temperature of 200° C., load of 49N) are 2 g/10 minutes or more, and 15 g/10 minutes or less.

The blend amount of the copolymer of styrene-based hydrocarbon and aliphatic carboxylic acid ester is adjusted as appropriate depending on the compositional ratio thereof and is adjusted in the range of 20 mass % or more and 70 mass % or less based on the total mass of the resin that constitutes the intermediate layer. When the blend amount is 70 mass % or less, the rigidity of the film can be greatly improved without greatly decreasing the rupture resistance. When the blend amount is 20 mass % or more, the effect of film rigidity can be exhibited.

The intermediate layer that constitutes the inventive film can contain a polyester-based resin in the range of 3 mass % or more and 30 mass % or less, preferably in the range of 5 mass % or more and 20 mass % or less, based on the total resin that constitutes the intermediate layer. The polyester-based resin that can be used includes polyester-based resins similar to the polyester-based resins that are used as the main component in the above-mentioned front and back layers. The inventive film may contain resins that are used in the front and back layers in the intermediate layer, so that the addition for regeneration can be realized and further, the intermediate layer becomes more compatible with the front and back layers, thus increasing inter layer strength between the front and back layers and the intermediate layer. This allows improvement in rupture resistance of the film to be expected. When the blend amount of the polyester-based resin is 3 mass % or more, sufficient inter layer strength and/or improvement in rupture resistance can be realized and when the blend amount is 30 mass % or less, the transparency of the film is not deteriorated.

<Adhesive Layer>

The inventive film can be of a structure such that the film has an adhesive layer between the intermediate layer and the front and back layers. The most advantageously used resin as an adhesive layer is a mixed resin that includes the polyester-based resin and the polystyrene-based resin. Use of the mixed resin in the adhesive layer allows the polyester resin on the side of the front and back layers to adhere to the polyester component in the mixed resin and the polystyrene-based resin on the side of the intermediate layer to adhere to the polystyrene component in the mixed resin respectively, so that improvement of inter layer adhesive strength can be expected.

Further, as the resin that constitutes the adhesive layer, a resin other than the mixed resin may be used in a range where the transparency of the film after addition for regeneration is taken into consideration. Such a resin includes, for example, copolymers of vinyl aromatic-based compounds and conjugated diene-based hydrocarbon or hydrogenated derivatives thereof. Here, styrene-based hydrocarbons are suitably used as the vinyl aromatic-based compound and styrene homologues or the like such as α-methylstyrene may be advantageously used. On the other hand, the conjugated diene-based hydrocarbon includes, for example, 1,3-butadiene, isoprene, and 1,3-pentadiene. These may be used singly or two or more of them may be used in admixture. Further, a small amount of a component other than the vinyl aromatic-based compound and the conjugated diene-based hydrocarbon may be contained as a third component. By allowing many double bonds mainly derived from the vinyl bonds of the conjugated diene portions to exist, the adhesive layer becomes compatible with the polyester-based resin in the front and back layers, so that the inter layer adhesive strength can be improved, which is preferable.

When a copolymer of the styrene-based hydrocarbon and the conjugated diene-based hydrocarbon or hydrogenated derivatives thereof is used as the resin that constitutes an adhesive layer, the content of the styrene-based hydrocarbon is preferably 5 mass % or more and 40 mass % or less, more preferably 10 mass % or more and 35 mass % or less. When the content of the styrene-based hydrocarbon is 5 mass % or more, the compatibility of the resin when the film is added for regeneration to the resin that constitutes the front and back layers and/or the resin that constitutes intermediate layer (usually added to the resin that constitutes the intermediate layer) is good, so that a film that retains transparency can be obtained. On the other hand, when the content of the styrene-based hydrocarbon is 40 mass % or less, the adhesive layer has sufficient flexibility; for example, when stress or impact is added to the whole film, the adhesive layer serves as a cushion to the stress generated between the front and back layers and the intermediate layer, thus suppressing inter layer separation.

Further, the glass transition temperature (Tg) of the copolymer of the vinyl aromatic-based compound and the conjugated diene-based hydrocarbon or hydrogenated derivatives thereof is preferably 20° C. or less, and more preferably 10° C. or less, and still more preferably 0° C. or less. When Tg is 20° C. or less, the flexible adhesive layer can function as a cushion when stress is applied to the laminate film, so that the inter layer separation can be suppressed, which is practically preferable.

Note that Tg in the present invention is a value obtained as follows. That is, by using a viscoelastic spectrometer DVA-200 (manufactured by IT Measurement Co., Ltd.), measurement is performed at an oscillation frequency of 10 Hz, a strain of 0.1% and a temperature elevation speed of 3° C./minute and a peak value of loss elastic modulus (E″) is obtained from the obtained data and the temperature at that time is defined as Tg. When a plurality of peaks of loss elastic modulus (E″) is present, the temperature of peak value at which the loss elastic modulus (E″) shows the maximum value is defined as Tg.

The copolymer of the vinyl aromatic-based compound and the conjugated diene-based hydrocarbon or hydrogenated derivatives thereof include those which are commercially available, for example, styrene-butadiene block copolymer elastomer (trade name “TAFPRENE”, manufactured by Asahi Kasei Corporation), styrene-butadiene block copolymer hydrogenated derivatives (trade name “TAFTEK H”, manufactured by Asahi Kasei Corporation; trade name “CLAYTON G”, manufactured by shell Japan Co., Ltd.), styrene-butadiene random copolymer hydrogenated derivative (trade name “DYNALON”, manufactured by JSR Co.), styrene-isoprene block copolymer hydrogenated derivative (trade name “SEPTON”, manufactured by Kuraray Co., Ltd.), and styrene-vinylisoprene block copolymer elastomer (trade name “HYBRAR”, manufactured by Kuraray Co.).

The copolymer of the vinyl aromatic-based compound and the conjugated diene-based hydrocarbon or hydrogenated derivatives thereof can exhibit a further improved inter layer adhesion with the front and back layers constituted by the polyester-based resin by introduction of a polar group. Examples of the polar group include an acid anhydride group, a carboxylic acid group, a carboxylic acid ester group, a carboxylic acid chloride group, a carboxylic acid amide group, a carboxylate group, a sulfonic acid group, a sulfonic acid ester group, a sulfonic acid chloride group, a sulfonic acid amide group, a sulfonate group, an epoxy group, an amino group, an imido group, an oxazoline group, and a hydroxyl group. Typical examples of the copolymers of the vinyl aromatic-based compound and the conjugated diene-based hydrocarbon, that is introduced a polar group, or hydrogenated derivatives thereof include maleic anhydride-modified SEBS, maleic anhydride-modified SEPS, epoxy-modified SEBS, and epoxy-modified SEPS. Specifically, trade name “TAFTEK M”, manufactured by Asahi Kasei Corporation, trade name “EPOFRIEND”, manufactured by Daicel Chemical Co., Ltd. and so on are commercially available. These copolymers can be used singly or two or more of them as mixtures.

In the present invention, the front and back layers and/or intermediate layer, and further adhesive layer may contain, besides the above-mentioned components, recycled resins generated from trimming losses such as cut edges of films, inorganic particles such as silica, talc, kaolin, calcium carbonate, etc., additives such as pigments such as titanium oxide, carbon black, etc., flame retardants, weatherability stabilizers, heat-resistant stabilizers, antistatic agents, melt viscosity improvers, crosslinking agents, lubricants, nucleating agents, plasticizers, antioxidants, and so on as appropriate as far as the effects of the present invention are not significantly inhibited in order to improve or adjust molding processability, productivity and various physical properties of heat-shrinkable film.

(Layer Construction of Film)

The heat-shrinkable film of the present invention is not particularly limited with respect to its layer construction as far as it has at least three layers constituted by an intermediate layer, and front and back layers laminated on both sides of the intermediate layer. Here, “front and back layers laminated on both sides of the intermediate layer” refers to the case where the front and back layers are laminated adjacent to the intermediate layer (first mode) but also the case where a third layer (for example, an adhesive layer) is present between the intermediate layer and the front and back layers. The intermediate layer may contain layers similar to the front and back layers.

In the present invention, the lamination construction of the film is a three-layered one consisting of front (back) layer/intermediate layer/(front) back layer and a more preferable layer construction is a five-layered one consisting of front (back) layer/adhesive layer/intermediate layer/adhesive layer/(front) back layer. Adoption of this layer construction enables to provide a heat-shrinkable laminate film suitable for particularly a heat-shrinkable label or the like, having excellent rigidity and shrink finishing quality of a film with excellent productivity and cost performance.

Then, the three-layered laminate film of front (or back) layer/intermediate layer/adhesive layer, which consists of front and back layers and an intermediate layer, and a five-layered laminate film of front (back) layer/adhesive layer/intermediate layer/adhesive layer/(front) back layer are described.

In the case where an adhesive layer is present between the intermediate layer and the front and back layers, the adhesive layer is of 0.5 μm or more, preferably 0.75 μm or more, and more preferably 1 μm or more, and 6 μm or less, preferably 5 μm or less as an upper limit from its function.

While the total thickness of the inventive film is not particularly limited, a smaller total thickness is more preferable from the viewpoints of transparency, shrinkage processability, raw material cost and so on. Specifically, the total thickness of the inventive film is 80 μm or less, preferably 70 μm or less, more preferably 50 μm or less, and most preferably 40 μm or less. On the other hand, the lower limit of the total thickness of the inventive film is not particularly limited but it is preferably 20 μm or more taking into consideration the handleability of the film.

<Physical/Mechanical Characteristics>

It is preferable that the inventive film has a tensile elastic modulus of 1,300 MPa or more and more preferably 1,400 MPa or more in a direction perpendicular to the main shrink direction of the film from the view point for rigidity. The upper limit value of the tensile elastic modulus of a heat-shrinkable film that is usually used is about 3,000 MPa, preferably about 2,900 MPa, and more preferably about 2,800 MPa. When the tensile elastic modulus in a direction perpendicular to the main shrink direction of the film is 1,300 MPa or more, the rigidity of the whole film can be increased. This is preferable, since in particular, even when the thickness of the film is made small, problems that when a bag-made film is attached to a container such as a PET bottle by a labeling machine or the like, the film is obliquely attached, and that yield tends to be decreased due to a buckling of the film, may hardly occur. It is preferable that an average value of tensile elastic modulus in MD and a direction perpendicular thereto (TD) of each film is 1,500 MPa or more, more preferably 1,700 MPa or more.

The tensile elastic modulus can be measured according to the Japan Industrial Standards, JIS K7127 under condition of 23° C.

The tensile elastic modulus in the main shrink direction of the film is not particularly limited as far as the film has nurve and is 1,500 MPa or more, preferably 2,000 MPa or more, and more preferably 2,500 MPa or more, and 6,000 MPa or less, preferably 4,500 MPa or less, and more preferably 3,500 MPa or less as an upper limit. Setting the tensile elastic modulus of the film in the main shrink direction of the film to the above-mentioned range is preferable since the nurve of the film can be increased in both directions.

It is desirable that the natural shrink ratio of the inventive film is as small as possible. It is desired that generally, the natural shrink ratio of a heat-shrinkable film, for example, after storage at 30° C. for 30 days is 1.5% or less, preferably 1.0% or less. When the natural shrink ratio under the above-mentioned conditions is 1.5% or less, the film can be attached stably to a container or the like even after storage for a long period of time and there tends to cause substantially no problem.

The transparency of the inventive film is such that when a film of, for example, 50 μm thick is measured according to the Japan Industrial Standards, JIS K7105, it has a haze value of preferably 10% or less, more preferably 7% or less, and still more preferably 5% or less. When the film has a haze value of 10% or less, the film has transparency, so that it can exhibit a display effect.

Preferably, the inventive film, even when the film is added for regeneration to the front layer, intermediate layer, or adhesive layer, preferably intermediate layer in the range of 30 mass % or less, preferably 25 mass % or less, and more preferably 20 mass % or less based on total amount of the resin that constitutes each layer, has a haze value of 10% or less, preferably 7% or less, and more preferably 5% or less when measured for a film of 50 μm thick according to JIS K7105. When the film has a haze value of 10% or less after addition for regeneration, acceptable transparency in the regenerated film can be maintained.

The rupture resistance of the inventive film is evaluated based on a tensile elongation at break and in a tensile break test in an environment at 0° C., in particular for label applications, rate of elongation in a direction of taking up of film (a direction of flow of film) (MD) is 100% or more, preferably 200% or more, and more preferably 300% or more. When the tensile elongation at break in the environment at 0° C. is 100% or more, troubles such as film breakage during the steps of printing, bag making, etc. is difficult to occur, which is preferable. Further, even when tensile force is increased along with speeding up of the steps of printing, bag making, etc., the film is difficult to be broken if the tensile elongation at break is 200% or more, which is more preferable.

The seal strength of the inventive film is 3N/15 mm width or more, preferably 5N/15 mm width or more, more preferably 7N/15 mm width or more as measured by the method described in the examples described later (a method of peeling at a test speed of 200 mm/minute in TD by T-type peeling method in the environment at 23° C. and 50% RH. Although there is no particular upper limit is posed on inter layer peeling strength, it is preferable that the inter layer peeling strength is about 15N/15 mm width from the viewpoint of resistance to solvents of the surface of the film.

The inventive film has a seal strength of at least 3N/15 mm width, so that troubles such as peeling of the sealed portion does not occur. Further, the inter layer peeling strength after the inventive film is heat-shrunk is acceptable, so that a strength that is identical with the inter layer peeling strength before the heat shrink can be maintained.

<Method of Producing a Film>

The inventive film can be produced by a known method. The form of the film may be either planar or tubular. From the viewpoint of productivity (enabling a plurality of products to be obtained in a width direction of the original film) or capability of being printed on inner side thereof, it is preferable that the film is planar. The method of producing a planar film is exemplified by a method that involves melting a resin using a plurality of extruders, coextruding the molten resin from T-dies, cooling and solidifying the resin on a chilled roll, drawing the solidified resin in a longitudinal direction, performing tenter drawing in a transverse direction, annealing and cooling the resultant (when the product is to be printed, effecting corona discharging on the surface on which printing is to be performed), and winding the product by a take-up machine, thereby obtaining a film. Also, a method of cutting a film produced by a tubular method to make it planar can be applied. Further, resin for constituting an intermediate layer and resins for constituting front and back layers may be separately processed to form sheets, which then may be laminated by a press method or a roll-nip method.

The melt-extruded resin is cooled on a cooling roll, or with air or water and so on and then heated again by a suitable method, such as hot air, warm water, infrared ray and uni- or biaxially drawn by any one of a roll method, a tenter method, a tubular method or the like.

Also, in the case of an application which requires shrink characteristics substantially monoaxial direction such as a heat-shrinkable label for PET bottles, it is effective to perform drawing in a direction perpendicular to the uniaxial direction as far as the shrink characteristics are not inhibited. While the drawing temperature depends on the lamination construction and blended resins, typically the drawing temperature is 80° C. or more and 110° C. or less. Further, although with an increasing draw ratio, the rupture resistance is more improved, and the shrink ratio is increased along with this, so that acceptable shrink finishing quality is difficult to obtain. Accordingly, it is particularly preferable that the draw rate is 1.03 times or more and 1.5 times or less.

[Molded Product, Heat-Shrinkable Label and Container]

The inventive film has excellent shrink finishing quality, transparency and natural shrinkage of the film and its application is not particularly limited. By forming thereon a printing layer, a vapor deposition layer and other functional layers, the inventive film can be used as various molded articles for use in bottles (blow bottles), trays, lunchboxes, containers for prepared food, milk product containers and so on. In particular, in the case where the inventive film is used as a heat-shrinkable label for food containers (for example, PET bottles for beverage or food, and glass bottles, preferably PET bottles), the film can closely contact even complicated shapes (for example, a cylinder with a constricted center, a cornered quadratic prism, a pentagonal prism, a hexagonal prism and so on, so that containers (containers) with beautiful labels without any wrinkles or pockmarks can be obtained. The molded product and containers of the present invention can be fabricated by an ordinary molding method.

### EXAMPLES

Hereinafter, examples are described. However, the present invention should not be understood to be limited thereby. Note that measured values and evaluations shown in the examples were made as follows. Here, the direction of take-up (direction of flow) of the film is described as MD and a direction perpendicular to MD is described as TD.

(1) Heat Shrinkage Ratio

A film was cut to a size of MD 100 mm×TD 100 mm and then immersed in warm water baths ranging from 50° C. to 90° C. at an interval of 5° C. for 10 seconds and each heat shrinkage ratio in the film main shrink direction (TD), a direction (MD) perpendicular to the main shrink direction was measured. The heat shrinkage ratio is indicated by % value of the shrink ratio at the measurement temperature to the original size before the shrink.

(2) Birefringence Index

Birefringence index of the front layer and/or the back layer was measured by an Abbe refractometer according to JIS K7142.

(3) Natural Shrink Ratio

After a film was prepared, the film was left to stand at 23° C. for 5 hours and cut to a size of MD 50 mm and TD 1,000 mm. The resultant was left to stand in a homeostat bath in an atmosphere of 30° C. for 30 days, and then TD shrinkage ratio was measured. Natural shrink ratio was a shrinkage ratio after 30 days to the original size before shrink is expressed in % values.

(4) Tensile Elongation Ratio

A test piece was cut out of the film to a size of 15 mm wide and 50 mm long in the MD direction of the film. The test piece was set in a tensile test machine equipped with a homeostat at a chuck interval of 40 mm and the test piece was pulled at 0° C. and a test speed of 100 mm/min. Tensile elongation ratio was obtained according to the following equation.
Tensile elongation ratio (%)=(Length between chucks at rupture−40 (mm))/40 (mm)×100
(5) Transparency (Total Haze Value)

According to JIS K7105, the haze value of a film was measured at a film thickness of 50 μm.

(6) Tensile Elastic Modulus

The tensile elastic modulus of MD was obtained as follows. A film test piece of 3.0 mm wide was tested in tension at an environment temperature of 23° C. with a chuck interval of 80.0 mm at a pulling speed of 5.0 mm/min. The tensile elastic modulus of TD was as follows. A film test piece of 5 mm wide was tested in tension at an environment temperature of 23° C. with a chuck interval of 300.0 mm at a pulling speed of 5.0 mu/min. Using a linear part of the obtained tensile stress-strain curve, tensile elastic modulus was calculated according to the following equation.
E=σ/ε
E: tensile elastic modulus
σ: a difference in stress per unit area (average cross-sectional area of sample before tensile test) between two points on the line
   (7) Shrink Finishing Quality

A sample of a size of MD 100 mm×TD 298 mm with grating patterns of 10 mm in interval in the transverse direction printed thereon was cut out of the obtained sheet. Both ends of the sample in TD were superposed one on another in a width of 10 mm and sealed with a solvent or the like to form a cylindrical structure. The cylindrical sheet was attached onto a 500-ml PET bottle and the PET bottle was passed through a 3.2-m-long (3 zones) shrink tunnel of a steam heating type in about 4 seconds without rotating the bottle. The atmosphere temperature in the tunnel in each zone was set to 80 to 90° C. by adjusting the amount of vapor by a vapor valve.

The sheet covering the PET bottle was evaluated for shrink finishing quality based on the following evaluation criteria.

Evaluation Criteria:

⊚ Sufficiently shrunk, showing no wrinkles, no pockmarks, no deformation of grating patterns, with good adhesion;

◯ Sufficiently shrunk, showing a slight wrinkle, as light pockmark, a slight deformation of grating patterns or showing a slight noticeable shrink in the longitudinal direction, raising substantially no practical problem; and

X Apparently showing insufficient shrink or marked shrink in vertical direction, raising practical problems.

(8) Measurement of Viscoelasticity (Storage Elastic Modulus, Loss Elastic Modulus)

Measurement was performed using a viscoelasticity spectrometer DVA-200 (manufactured by IT Measurement Co., Ltd.), under conditions of a vibrational frequency of 10 Hz, a heat elevation speed of 3° C./minute at a measurement temperature in a range of −120° C. to 130° C. The peak temperature of loss elastic modulus was obtained as a temperature at which temperature-dependent curve of loss elastic modulus has an inclination of zero (first derivation being zero). Note that the film to be measured was prepared by forming the resin that constitutes it to a thickness of about 0.2 to 1.0 mm and the direction in which there was substantially no orientation was measured. That is, after the constituent resin was extruded through an extruder, a horizontal direction was measured. Alternatively, measurement was performed after the orientation was relaxed by a hot press. Note that the film of constituent resin may be measured after it is heat-pressed into a sheet regardless of whether it is drawn or undrawn.

(9) Refractive Index

According to JIS K7142, the resin or resin mixture as an object of measurement was formed into a film having a thickness in a range of about 50 μm to about 500 μm and the obtained film was measured using an Abbe refractometer.

### Example I-1

As shown in Table 1, a mixed resin (refractive index of the mixed resin 1.581) of 55 mass % of polystyrene-based resin: SBS-1 (styrene/butadiene=90/10 mass %, average refractive index 1.589) and 45 mass % of polystyrene-based resin: SBS-2 (styrene/butadiene=70/30 mass %, average refractive index 1.571) was used as an intermediate layer, and polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) was used as front and back layers. These resins were molten in an extruder with an extrusion amount of intermediate layer:front and back layers=3:1 at a temperature in a range of 210 to 230° C. for the intermediate layer and at a temperature in a range of 220 to 240° C. for the front and back layers, and merged in a mouthpiece at 230° C. and extruded in the form of two-type three-layer film (extrusion amount ratio=1:6:1), followed by cooling on a cast roll to obtain an undrawn film. The undrawn film was drawn 1.3 times in the flow direction (MD) at 80° C. and then 4.05 times in a direction perpendicular (TD) to the MD at 94° C. to prepare a film having a thickness of about 50 μm (lamination ratio=1/7/1). Results of evaluation of the obtained film are shown in Tables 2 and 3.

### Example I-2

As shown in Table 1, a polystyrene-based resin: SBS-3 (styrene/butadiene=76/24 mass %, average refractive index 1.571) was used as an intermediate layer, and polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) was used as front and back layers. These resins were molten in an extruder with an extrusion amount of intermediate layer:front and back layers=3:2 at a temperature in a range of 200 to 220° C. for the intermediate layer and at a temperature in a range of 220 to 240° C. for the front and back layers, and merged in a mouthpiece at 230° C. and extruded in the form of two-type three-layer film (extrusion amount ratio=1:3:1), followed by cooling on a cast roll to obtain an undrawn film. The undrawn film was drawn 1.3 times in the flow direction (MD) at 80° C. and then 4.0 times in a direction perpendicular (TD) to the MD at 93° C. to prepare a film having a thickness of about 50 μm (lamination ratio=1/4/1). Results of evaluation of the obtained film are shown in Tables 2 and 3.

### Example I-3

As shown in Table 1, a mixed resin (refractive index of the mixed resin 1.581) of 55 mass % of polystyrene-based resin: SBS-1 (styrene/butadiene=90/10 mass %, average refractive index 1.589) and 45 mass % of polystyrene-based resin: SBS-2 (styrene/butadiene=70/30 mass %, average refractive index 1.571) was used as an intermediate layer, and a mixed resin consisting of 90 mass % of a polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) and 10 mass % of a polyester resin: PET-2 (polybutylene terephthalate consisting of 100 mol % of terephthalic acid as a dicarboxylic acid component, and 100 mol % of 1,4-butanediol as a glycol component) was used as front and back layers. These resins were molten in an extruder with an extrusion amount of intermediate layer:front and back layers=3:1 at a temperature in a range of 210 to 230° C. for the intermediate layer and at a temperature in a range of 220 to 240° C. for the front and back layers, and merged in a mouthpiece at 230° C. and extruded in the form of two-type three-layer film (extrusion amount ratio=1:6:1), followed by cooling on a cast roll to obtain an undrawn film. The undrawn film was drawn 1.3 times in the direction (MD) at 80° C. and then 4.05 times in a direction perpendicular (TD) to the MD at 94° C. to prepare a film having a thickness of about 50 μm (lamination ratio=1/7/1). Results of evaluation of the obtained film are shown in Tables 2 and 3.

### Example I-4

As shown in Table 1, a mixed resin (refractive index of the mixed resin 1.581) of 55 mass % of polystyrene-based resin: SBS-1 (styrene/butadiene=90/10 mass %, average refractive index 1.589) and 45 mass % of polystyrene-based resin: SBS-2 (styrene/butadiene=70/30 mass %, average refractive index 1.571) was used as an intermediate layer, and a mixed resin of 90 mass % of a polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) and 10 mass % of a polyester-based resin: PET-2 (polybutylene terephthalate consisting of 100 mol % of terephthalic acid as a dicarboxylic acid component, and 100 mol % of 1,4-butanediol as a glycol component) was used as front and back layers. A hydrogenated styrene-based thermoplastic elastomer resin: SEBS (styrene/ethylene-butylene=30/70) was used as an adhesive layer. These resins were molten in an extruder with an extrusion amount of intermediate layer:adhesive layer:front and back layers=3:1:2 at a temperature in a range of 210 to 230° C. for the intermediate layer and at a temperature in a range of 220 to 240° C. for the front and back layers, and at a temperature of 210 to 230° C. for the adhesive layer, and merged in a mouthpiece at 230° C. and extruded in the form of three-type five-layer film (extrusion amount ratio=2:1:6:1:2), followed by cooling on a cast roll to obtain an undrawn film. The undrawn film was drawn 1.3 times in the direction of flow (MD) at 82° C. and then 4.0 times in a direction perpendicular (TD) to the MD at 92° C. to prepare a film having a thickness of about 50 μm (lamination ratio=2/1/7/1/2). Results of evaluation of the obtained film are shown in Tables 2 and 3.

### Example I-5

As shown in Table 1, a mixed resin (refractive index of the mixed resin 1.581) of 50 mass % of polystyrene-based resin: SBS-1 (styrene/butadiene=90/10 mass %, average refractive index 1.589), 40 mass % of polystyrene-based resin: SBS-2 (styrene/butadiene=70/30 mass %, average refractive index 1.571), and a mixed resin of 10 mass % of a polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) were used as an intermediate layer, and a polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) was used as front and back layers. These resins were molten in an extruder with an extrusion amount of intermediate layer:front and back layers=3:1 at a temperature in a range of 220 to 235° C. for the intermediate layer and at a temperature in a range of 220 to 240° C. for the front and back layers, and merged in a mouthpiece at 230° C. and extruded in the form of two-type three-layer film (extrusion amount ratio=1:6:1), followed by cooling on a cast roll to obtain an undrawn film. The undrawn film was drawn 1.3 times in the direction of flow (MD) at 80° C. and then 4.05 times in a direction perpendicular (TD) to the MD at 94° C. to prepare a film having a thickness of about 50 μm (lamination ratio=1/7/1). Results of evaluation of the obtained film are shown in Tables 2 and 3.

### Comparative Example I-1

As shown in Table 1, a mixed resin (refractive index of the mixed resin 1.581) of 55 mass % of polystyrene-based resin: SBS-1 (styrene/butadiene=90/10 mass %, average refractive index 1.589) and 45 mass % of polystyrene-based resin: SBS-2 (styrene/butadiene=70/30 mass %, average refractive index 1.571) was used as an intermediate layer, and polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) was used as front and back layers. These resins were molten in an extruder with an extrusion amount of intermediate layer:front and back layers=1:4 at a temperature in a range of 210 to 230° C. for the intermediate layer and at a temperature in a range of 220 to 240° C. for the front and back layers, and merged in a mouthpiece at 230° C. and extruded in the form of two-type three-layer film (extrusion amount ratio=2:1:2), followed by cooling on a cast roll to obtain an undrawn film. The undrawn film was drawn 1.3 times in the direction of flow (MD) at 80° C. and then 4.05 times in a direction perpendicular (TD) to the MD at 94° C. to prepare a film having a thickness of about 50 μm (lamination ratio=1/0.6/1). Results of evaluation of the obtained film are shown in Tables 2 and

### Comparative Example I-2

As shown in Table 1, a mixed resin consisting of 90 mass % of a polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) and 10 mass % of polyester resin: PET-2 (polybutylene terephthalate consisting of 100 mol % of terephthalic acid as a dicarboxylic acid component, and 100 mol % of 1,4-butanediol as a glycol component) was molten in an extruder at a temperature in a range of 220 to 240° C. and extruded through a mouthpiece at 235° C., followed by cooling on a cast roll to obtain an undrawn film. The undrawn film was drawn 1.03 times in the direction of flow (MD) at 70° C. and then 4.0 times in a direction perpendicular (TD) to the MD at 84° C. to prepare a film having a thickness of about 50 μm. Results of evaluation of the obtained film are shown in Tables 2 and 3.

### Comparative Example I-3

As shown in Table 1, a mixed resin (refractive index of the mixed resin 1.581) of 55 mass % of polystyrene-based resin: SBS-1 (styrene/butadiene=90/10 mass %, average refractive index 1.589) and 45 mass % of polystyrene-based resin: SBS-2 (styrene/butadiene=70/30 mass %, average refractive index 1.571) was molten in an extruder set at a temperature in a range of 210 to 230° C. and extruded through a mouthpiece, followed by cooling on a cast roll to obtain an undrawn film. The undrawn film was drawn 1.3 times in the direction of flow (MD) at 85° C. and then 4.05 times in a direction perpendicular (TD) to the MD at 94° C. to prepare a film having a thickness of about 50 μm. Results of evaluation of the obtained film are shown in Tables 2 and 3.

### Comparative Example I-4

As shown in Table 1, a mixed resin consisting of 90 mass % of a polystyrene-based resin: MS-1 (rubbery elastic body-dispersed polystyrene resin including a continuous phase of a copolymer of styrene/methyl methacrylate/butyl acrylate=47/38/8 and 7 mass % of a styrene/butadiene copolymer contained as dispersion particles (average particle size 0.5 μm) in the continuous phase, average refractive index 1.544) and 10 mass % of a polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) was used as an intermediate layer, and a polyester-based resin: PET-1 (a copolymer polyester consisting of 100 mol % of terephthalic acid as a dicarboxylic acid component, and 68 mol % of ethylene glycol and 32 mol % of 1,4-cyclohexanedimethanol as a glycol component) was used as front and back layers. These resins were molten in an extruder in an extrusion amount of intermediate layer:front and back layers=3:1 at a temperature in a range of 210 to 235° C. for the intermediate layer and at a temperature in a range of 220 to 240° C. for the front and back layers, and merged through a mouthpiece at 230° C. and extruded in the form of two-type three-layer (extrusion amount ratio=1:6:1), followed by cooling on a cast roll to obtain an undrawn film. The undrawn film was drawn 1.03 times in the flow direction (MD) at 90° C. and then 4.0 times in a direction perpendicular (TD) to the MD at 88° C. to prepare a film having a thickness of about 50 μm (lamination ratio=1/7/1). Results of evaluation of the obtained film are shown in Tables 2 and 3.

TABLE 1

| | Intermediate | Front and | Adhesive |
|---|---|---|---|
| | layer | back layers | layer |
| Example I-1 | SBS-1/SBS-2 = | PET-1 | — |
| | 55/45 | | |
| Example I-2 | SBS-3 | PET-1 | — |
| Example I-3 | SBS-1/SBS-2 = | PET-1/PET-2 = | — |
| | 55/45 | 90/10 | |
| Example I-4 | SBS-1/SBS-2 = | PET-1/PET-2 = | SEBS |
| | 55/45 | 90/10 | |
| Example I-5 | SBS-1/SBS-2/PET-1 = | PET-1 | — |
| | 50/40/10 | | |
| Comparative | SBS-1/SBS-2 = | PET-1 | — |
| Example I-1 | 55/45 | | |
| Comparative | PET-1/PET-2 = 90/10 | | |
| Example I-2 | | | |
| Comparative | SBS-1/SBS-2 = 55/45 | | |
| Example I-3 | | | |
| Comparative | MS-1/PET-1 = | PET-1 | — |
| Example I-4 | 90/10 | | |

TABLE 2

| | Heat shrinkage ratio (%) | | | | | |
|---|---|---|---|---|---|---|
| | Temperature | | | | | |
| | indicating 30% | Perpendicular Direction (MD) | | | Intermediate | |
| | in the main | | Maximum | Minimum | layer | |
| | shrink | Range | shrinkage | shrinkage | refractive | Birefringence |
| | direction (° C.) | (° C.) | ratio | ratio | index | Δn (10⁻³) |
| Example I-1 | 72 | 62-77 | 1.5 | 0.0 | 1.581 | 22 |
| Example I-2 | 72 | 62-77 | 1.5 | 0.0 | 1.571 | 25 |
| Example I-3 | 72 | 62-77 | 1.6 | 0.0 | 1.581 | 33 |
| Example I-4 | 74 | 64-79 | 1.3 | 0.0 | 1.581 | 73 |
| Example I-5 | 72 | 62-77 | 1.5 | 0.0 | 1.581 | 22.9 |
| Comparative | 74 | 64-79 | 6.0 | 0.0 | 1.581 | 34 |
| Example I-1 | | | | | | |
| Comparative | 72 | 62-77 | 7.0 | −1.0 | — | 112 |
| Example I-2 | | | | | | |
| Comparative | 75 | 65-80 | 1.0 | 0.0 | — | — |
| Example I-3 | | | | | | |
| Comparative | 76 | 66-81 | 5.0 | 0.0 | 1.544 | 89 |
| Example I-4 | | | | | | |

TABLE 3

| | Thickness | Tensile | Tensile | | | | |
|---|---|---|---|---|---|---|---|
| | ratio of | elongation | elastic | | | | Natural |
| | Front and | ratio | modulus | | | | shrink |
| | back | MD: 0° C. | (MPa) | | Shrink | Transparency | ratio |
| | layers | (%) | MD | TD | finish | (%) | (%) |
| Example I-1 | 22 | 265 | 1430 | 1990 | ⊚ | 2.9 | 0.44 |
| Example I-2 | 33 | 351 | 1470 | 2890 | ◯ | 2.8 | 0.44 |
| Example I-3 | 22 | 350 | 1460 | 1990 | ⊚ | 3.4 | 0.4 |
| Example I-4 | 30 | 330 | 1510 | 2600 | ⊚ | 3.8 | 0.38 |
| Example I-5 | 22 | 341 | 1510 | 2050 | ⊚ | 4 | 0.38 |
| Comparative | 76 | 445 | 1630 | 3100 | X | 2.7 | 0.37 |
| Example I-1 | | | | | | | |
| Comparative | — | 670 | 1700 | 3930 | X | 2.5 | 0.23 |
| Example I-2 | | | | | | | |
| Comparative | — | 320 | 1200 | 1450 | ⊚ | 2.7 | 1.99 |
| Example I-3 | | | | | | | |
| Comparative | 22 | 190 | 1800 | 3200 | X | 9.5 | 0.35 |
| Example I-4 | | | | | | | |

Tables 2 and 3 demonstrate that those films having a thickness ratio of the thickness of the polyester-based resin layer (front and back layers) to the thickness of the whole film, birefringence index, temperature indicating a shrink ratio of 30%, and MD heat shrinkage ratio that are within the ranges of the present invention (Examples I-1 to I-5) have excellent shrink finishing quality, rigidity (tensile elastic modulus), and transparency.

On the contrary, in each of the case where the thickness ratio of the front and back layers exceeds 70% (Comparative Example I-1), the case where the birefringence index exceeds 80.0×10⁻³ (Comparative Example I-4), the case where MD heat shrinkage ratio exceeds ±5% (Comparative Examples I-1 and I-2), shrink finishing quality was poor. Further, in the case of a single layer of the polyester-based resin (Comparative Example I-2), shrink finishing quality was poor while in the case of a single layer of the polystyrene-based resin (Comparative Example I-3), the shrink finishing quality was good but the rigidity of the film was inferior.

From the above, it can be seen that the film of the present invention has good shrink finishing quality, rigidity (tensile elastic modulus), and transparency.

### Example II-1

A polystyrene-based resin A (styrene/butadiene=84/16 (mass %), E′ (0° C.)=1.69×10⁸ Pa, E″ peak temperature −44° C., refractive index 1.578) was used as an intermediate layer, a polyester-based resin B (a copolymer polyester consisting of 100 mol % of terephthalic acid as a dicarboxylic acid component and 70 mol % of ethylene glycol and 30 mol % of 1,4-cyclohexanedimethanol as a glycol component, refractive index 1.568, trade name PETG6763, manufactured by Eastman Chemical Co.) was used as front and back layers in an extrusion amount of intermediate layer:front and back layers=3:1, these resins were molten in an extruder set at a temperature in a range of 210° C. to 230° C., merged in a mouthpiece and extruded in the form of two-type three-layer (lamination ratio=1:6:1), followed by cooling on a cast roll to obtain an undrawn film. The undrawn film was drawn 1.3 times in the direction of flow (MD) having a thickness of about 300 μm. at 70° C. and then 4.5 times in a direction (TD) perpendicular to the MD direction at 90° C. to prepare a film having a thickness of about 50 μm (lamination ratio=1:6:1).

### Example II-2

Example II-1 was repeated except that a mixed resin (refractive index of the mixed resin: 1.581) consisting of 50 mass % of a polystyrene-based resin C (styrene/butadiene=90/10 (mass %), E′=3.15×10⁹ Pa, E″ peak temperature 55° C.) and 50 mass % of a polystyrene-based resin D (styrene/butadiene/isoprene=71/14/15 (mass %), E′(0° C.)=4.03×10⁸ Pa, E″ peak temperature −32° C.) was used as an intermediate layer and drawn 4.8 times in a perpendicular direction (TD) at 95° C.

### Example II-3

Example II-1 was repeated except that a mixed resin (refractive index of the mixed resin: 1.580) consisting of 45 mass % of the polystyrene-based resin C and 45 mass % of the polyester-based resin B was used as an intermediate layer and drawn 4.6 times in the perpendicular direction (TD) at 96° C.

### Example II-4

Example II-3 was repeated except that a mixed resin (refractive index of the mixed resin: 1.573) consisting of 50 mass % of the polystyrene-based resin D and 50 mass % of the polystyrene-based resin E (styrene/butyl acrylate=83/17 (mass %), E′=3.01×10⁹ Pa, E″ peak temperature 78° C.) was used as an intermediate layer.

### Comparative Example II-1

Example II-1 was repeated except that a mixed resin (refractive index of the mixed resin: 1.544) consisting of 90 mass % of a rubbery elastic body-dispersed polystyrene resin (MFR 5.9, refractive index: 1.546) containing a copolymer consisting of 47 mass % of styrene, 38 mass % of methyl methacrylate, and 8 mass % of butyl acrylate in a continuous phase and 7 mass % of styrene-butadiene copolymer as dispersion particles (average particle size 0.5 μm) and 10 mass % of polyester-based resin B was used as an intermediate layer and the film was drawn 4.6 times in the perpendicular direction (TD) at 103° C.

### Comparative Example II-2

Example II-1 was repeated except that a mixed resin consisting of 50 mass % of the polystyrene-based resin C and 50 mass % of the polystyrene-based resin D was used as an intermediate layer, and a mixed resin consisting of 50 mass % of the polystyrene-based resin D and 50 mass % of the polystyrene-based resin E (styrene/butyl acrylate=83/17, E′=3.01×10⁹ Pa, E″ peak temperature 78° C.) was used as front and back layers, and the film was drawn 4.7 times in the perpendicular direction (TD) at 95° C.

### Reference Example 1

Example II-1 was repeated except that a mixed resin consisting of 75 mass % of styrene resin F (styrene=100, E′=2.90×10⁹ Pa, E″ peak temperature 108° C.), 15 mass % of polystyrene-based resin D, and 10 mass % of polyester-based resin B was used as an intermediate layer, and the film was drawn 1.0 timed in the direction of flow (MD) at 70° C., and then, the film was drawn 4.0 folds in the perpendicular direction (TD) at 105° C. The obtained film had poor transparency.

### Reference Example 2

Example II-1 was repeated except that a mixed resin consisting of 90 mass % of polystyrene-based resin G (styrene/butadiene=40/60, refractive index 1.545, E′=1.59×10⁸ Pa, E″ peak temperature −78° C.), and 10 mass % of the polyester-based resin B was used as an intermediate layer, and the film was drawn 4.0 times in the perpendicular direction (TD) at 90° C. The obtained film had poor transparency.

The obtained films of Examples II-1 to II-4, Comparative Examples II-1 and II-2, and Reference Examples 1 and 2 were measured and evaluated for shrinkage ratio, tensile elongation, tensile elastic modulus, transparency, shrink finishing quality, natural shrink ratio, and birefringence index. The results obtained are shown in Table 4.

Note that in Reference Examples, measurement was performed only on transparency.

TABLE 4

| | | | | Tensile | | | | Natural | |
|---|---|---|---|---|---|---|---|---|---|
| | Heat shrinkage | | | elon- | Tensile | | | shrink | |
| | ratio (%) | | | gAtion | elastic | | | ratio | |
| | 70° C. | 80° C. | | ratio | modulus | Transparency | Shrink | 30° C. × 30 | Birefringence |
| | TD | MD | TD | (MD: 0° C.) | (MD × TD)/2 | (%) | finish | days | Δ (10⁻³) |
| Example II-1 | 24 | 3 | 49 | 344 | 1860 | 4 | A | 1.08 | 25 |
| Example II-2 | 20 | 2 | 49 | 260 | 1710 | 2.9 | B | 0.44 | 34 |
| Example II-3 | 23 | 2 | 51 | 349 | 1780 | 4 | A | 0.38 | 23 |
| Example II-4 | 14 | 3 | 49 | 280 | 1885 | 3.7 | B | 0.48 | 24 |
| Comparative | 5 | 0 | 40 | 110 | 2154 | 11.2 | C | 0.32 | 69 |
| Example II-1 | | | | | | | | | |
| Comparative | 15 | 1 | 44 | 116 | 1600 | 3.8 | A | 1.56 | — |
| Example II-2 | | | | | | | | | |
| Reference | — | — | — | — | — | 10.7 | — | — | — |
| Example 1 | | | | | | | | | |
| Reference | — | — | — | — | — | 16.3 | — | — | — |
| Example 2 | | | | | | | | | |

### INDUSTRIAL APPLICABILITY

The inventive film includes a polyester-based resin layer as front and back layers and a polystyrene-based resin layer as an intermediate layer in a predetermined lamination ratio and preferably has a predetermined heat shrinkage ratio and birefringence index, so that the film has excellent low temperature shrinkability, rigidity, and shrink finishing quality. Therefore, the film can be utilized for various molded products, in particular as a heat-shrinkable label.

1: A heat-shrinkable laminate film comprising:
an intermediate layer; and
front and back layers laminated on respective sides of the intermediate layer; wherein
the heat-shrinkable laminate film is drawn at least in one direction,
the intermediate layer comprises primarily at least one polystyrene-based resin having a block copolymer of a styrene-based hydrocarbon and a conjugated diene-based hydrocarbon,
the front and back layers comprise primarily at least one polyester-based resin,
the front and back layers have a thickness ratio based on the total thickness of 75% or less, and
a refractive index (n₁) of the polystyrene-based resin and a refractive index (n₂) of the polyester-based resin are in a relation of:
n₂−0.02≦n₁≦n₂+0.02.

2: The heat-shrinkable laminate film according to claim 1, wherein the front and back layers have each a birefringence index (Δn) of 1.0×10⁻³ or more and 80.0×10⁻³ or less.

3: The heat-shrinkable laminate film according to claim 1, wherein the film has a temperature T₃₀, which indicates a heat shrinkage ratio of 30% in a main shrink direction of the film after immersing for 10 seconds in warm water, in a range of 65° C. or more and 80° C. or less.

4: The heat-shrinkable laminate film according to claim 3, wherein the film has a heat shrinkage ratio of −5% or more and +5% or less in a direction perpendicular to a main shrink direction of the film in a temperature range of T₃₀−10° C. or more and T₃₀+5° C. or less.

5: The heat-shrinkable laminate film according to claim 1, wherein the polystyrene-based resin is a block copolymer.

6. (canceled)

7. (canceled)

8: The heat-shrinkable laminate film according to claim 1, wherein the refractive index (n₁) of the resin that constitutes the intermediate layer is 1.55 or more and 1.59 or less.

9: The heat-shrinkable laminate film according to claim 1, wherein the refractive index (n₂) of the resin that constitutes the front and back layers is 1.56 or more and 1.58 or less.

10: The heat-shrinkable laminate film according to claim 1, wherein the block copolymer of the styrene-based hydrocarbon and the conjugated diene-based hydrocarbon is selected from the group consisting of a styrene-butadiene block copolymer (SBS), a styrene-isoprene-butadiene block copolymer (SIBS), and a mixture thereof.

11: The heat-shrinkable laminate film according to claim 10, wherein a mass % ratio of styrene/butadiene of the SBS is (60 to 95)/(5 to 40).

12: The heat-shrinkable laminate film according to claim 10, wherein a mass % ratio of styrene/isoprene/butadiene of the SIBS is (60 to 85)/(10 to 40)/(5 to 30).

13: The heat-shrinkable laminate film according to claim 1, wherein the intermediate layer further comprises 20 mass % or less of a general-purpose polystyrene resin (GPPS) or 20 mass % or more and 60 mass % or less of a copolymer of a styrene-based hydrocarbon and an aliphatic unsaturated carboxylic acid ester.

14: The heat-shrinkable laminate film according to claim 13, wherein the copolymer of the styrene-based hydrocarbon and the aliphatic unsaturated carboxylic acid ester is a copolymer of styrene and butyl acrylate.

15: The heat-shrinkable laminate film according to claim 1, wherein a storage elastic modulus at 0° C. of the resin that constitutes the intermediate layer is 1.00×10⁹ Pa or more.

16: The heat-shrinkable laminate film according to claim 1, wherein the polyester-based resin is composed of a dicarboxylic acid component and a diol component, at least one of which is a mixture of two or more subcomponents (a first subcomponent, a second subcomponent, and optionally other subcomponent(s)), and wherein the total amount of the second subcomponent is 10 mol % or more and 40 mol % or less per the sum (200 mol %) of the total amount (100 mol %) of the dicarboxylic acid component and the total amount (100 mol %) of the diol component.

17: The heat-shrinkable laminate film according to claim 16, wherein the dicarboxylic acid component is terephthalic acid and the first subcomponent of the diol component is ethylene glycol and the second subcomponent is 1,4-cyclohexanedimethanol.

18: The heat-shrinkable laminate film according to claim 17, wherein an amount of 1,4-cyclohexanedimethanol is 25 mol % or more and 35 mol % or less per the sum (200 mol %) of the total amount (100 mol %) of the dicarboxylic acid component and the total amount (100 mol %) of the diol component.

19: The heat-shrinkable laminate film according to claim 1, wherein the intermediate layer further comprises a polyester-based resin and a content of the polyester-based resin is 3 mass % or more and 30 mass % or less per a total amount of the resins that constitute the intermediate layer.

20: The heat-shrinkable laminate film according to claim 1, wherein the laminate film has a total haze value of 10% or less when measured according to JIS K7105.

21: The heat-shrinkable laminate film according to claim 1, wherein the film has a heat shrinkage ratio of 10% or less in a main shrink direction after immersion for 10 seconds in warm water at 70° C.

22: The heat-shrinkable laminate film according to claim 1, further comprising an adhesive layer having a glass transition temperature (Tg) of 20° C. or less between the intermediate layer and the front and back layers.

23. (canceled)

24. (canceled)

25. (canceled)

26. The heat-shrinkable laminate film according to claim 1, further comprising an adhesive layer comprising a copolymer of a vinyl aromatic-based compound and a conjugated diene-based hydrocarbon, or a hydrogenated derivative of the copolymer.

27. The heat-shrinkable laminate film according to claim 1, wherein the intermediate layer further comprises a polyester-based resin, a content of the polyester-based resin is 3 mass % or more and 30 mass % or less based on a total amount of the resins that constitute the intermediate layer, and the laminate film has a total haze value of 10% or less when measured according to JIS K7105.

28: A molded product comprising the heat-shrinkable laminate film according to claim 1 as a base material.

29: A heat-shrinkable label comprising the heat-shrinkable laminate film according to claim 1 as a base material.

30: A container comprising the molded product according to claim 28, wherein the molded product is attached to the container.

31: A container comprising the heat-shrinkable label according to claim 29, wherein the heat-shrinkable label is attached to the container.
